(19) United States
(12) Patent Application Publication
(10) Pub. No.: US 2023/0207825 A1
(43) Pub. Date: Jun. 29, 2023

(54) ALKALI-METAL-ION SECONDARY BATTERY INCLUDING ALKALI METAL IONS AT HIGH DENSITY ON BOTH SIDES THEREOF

(71) Applicant: P&B Materials Co., Ltd., Yongin-si (KR)

(72) Inventors: Deuk-Il Park, Hwaseong-si (KR); Ki-Yong Baek, Cheonan-si (KR); Dae-Hwan You, Cheonan-si (KR)

(73) Assignee: P&B Materials Co., Ltd., Yongin-si (KR)

(21) Appl. No.: 17/590,860

(22) Filed: Feb. 2, 2022

(30) Foreign Application Priority Data
Dec. 27, 2021 (KR) 10-2021-0188356

(51) Int. Cl. H01M 4/62; H01M 10/0525; H01M 4/525

(52) U.S. Cl. CPC H01M 4/625; H01M 10/0525; H01M 4/525

(57) ABSTRACT

Disclosed is an alkali-metal-ion secondary battery including a cathode material, an electrolyte, a separator, and an anode material, in which each of the cathode material and the anode material includes an electrically conductive carbon allotrope and an alkali metal compound, the weights or composition ratios of the electrically conductive carbon allotropes contained in the cathode material and the anode material are different from each other, and the weights or composition ratios of the alkali metal compounds contained in the cathode material and the anode material are different from each other.

### BACKGROUND OF THE INVENTION

### Field of the Invention

The present invention relates to an alkali-metal-ion secondary battery including alkali metal ions at high density on both sides thereof, and more particularly to an alkali-metal-ion secondary battery including a cathode material, an electrolyte, a separator, and an anode material, in which each of the cathode material and the anode material includes an electrically conductive carbon allotrope and an alkali metal compound, the electrically conductive carbon allotrope contained in the cathode material and the electrically conductive carbon allotrope contained in the anode material being different from each other with regard to the weight or composition ratio thereof, and the alkali metal compound contained in the cathode material and the alkali metal compound contained in the anode material being different from each other with regard to the weight or composition ratio thereof.

### Description of the Related Art

As lithium-ion secondary batteries, which are one kind of alkali-metal-ion secondary battery, have begun to be used in electric vehicles, the demand for lithium-ion secondary batteries is rapidly increasing. However, electric vehicles using lithium-ion secondary batteries have disadvantages of short driving distances and long charge times, and problems related to the stability of secondary batteries due to vehicle fires, etc. and the lifespan thereof continue to emerge.

In order to expand the electric vehicle market, it is necessary to increase the capacity of currently available lithium-ion secondary batteries, realize fast charging, ensure high stability and a long lifespan, and stabilize the supply and price of raw materials for secondary batteries.

In order to realize high capacity, fast charging, and lifespan extension of alkali-metal-ion secondary batteries such as lithium-ion secondary batteries and to replace expensive materials in secondary battery materials with inexpensive materials, the present invention proposes a conceptually new charge-discharge mechanism, different from that of existing lithium-ion secondary batteries, along with new secondary battery materials.

### CITATION LIST

### Patent Literature

(Patent Document 0001) Korean Patent Application Publication No. 10-2008-0087823 (Laid-open date: Oct. 1,
(Patent Document 0002) Korean Patent Application Publication No. 10-2000-0058145 (Laid-open date: Sep. 25, 2000)

### SUMMARY OF THE INVENTION

It is an object of the present invention to provide an alkali-metal-ion secondary battery including a cathode material, an electrolyte, a separator, and an anode material, in which each of the cathode material and the anode material includes an electrically conductive carbon allotrope and an alkali metal compound, the electrically conductive carbon allotrope contained in the cathode material and the electrically conductive carbon allotrope contained in the anode material being different from each other with regard to the weight or composition ratio thereof, and the alkali metal compound contained in the cathode material and the alkali metal compound contained in the anode material being different from each other with regard to the weight or composition ratio thereof.

In order to accomplish the above object, the present invention provides an alkali-metal-ion secondary battery including a cathode material, an electrolyte, a separator, and an anode material, each of the cathode material and the anode material including an electrically conductive carbon allotrope and an alkali metal compound.

The weight or composition ratio of the electrically conductive carbon allotrope contained in the cathode material may be different from that of the electrically conductive carbon allotrope contained in the anode material.

Also, the weight or composition ratio of the alkali metal compound contained in the cathode material may be different from that of the alkali metal compound contained in the anode material.

Also, the electrically conductive carbon allotrope contained in each of the cathode material and the anode material may include at least one selected from among natural graphite, artificial graphite, low-crystalline carbon, activated carbon, graphene, and carbon nanotubes.

Also, the alkali metal compound contained in each of the cathode material and the anode material may include at least one selected from among a lithium compound and a sodium compound.

Also, the lithium compound may be synthesized from at least one selected from among lithium hydroxide, lithium oxide, and lithium carbonate.

Also, the sodium compound may be synthesized from at least one selected from among sodium chloride, sodium hydroxide, sodium oxide, and sodium carbonate.

Also, the alkali metal compound contained in each of the cathode material and the anode material may be synthesized from at least one material selected from among an inorganic compound and an organic compound, and the cathode material and the anode material may be prepared by forming the alkali metal compound or applying the alkali metal compound.

Also, the alkali metal compound contained in each of the cathode material and the anode material may be synthesized from at least one material selected from among an inorganic compound and an organic compound and at least one material selected from among electrically conductive carbon allotropes, and the cathode material and the anode material may be prepared by forming the alkali metal compound or applying the alkali metal compound.

Also, the organic compound used to synthesize the lithium compound or the sodium compound may include an organic compound containing an amino group (—NH₂).

Also, the organic compound containing an amino group (—NH₂) may be melamine or urea.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 shows a conventional secondary battery;

FIG. 2 shows a graph for Comparative Example 1;

FIG. 3 shows a graph for Comparative Example 2;

FIG. 4 shows a graph for Comparative Example 3;

FIG. 5 shows a graph for Example 1 according to the present invention;

FIG. 6 shows the chemical structural formula of melamine; and

FIG. 7 shows an electron microscope (SEM) image of a lithium compound including nanocarbon and multilayer graphene prepared in Example 1 according to the present invention.

### DETAILED DESCRIPTION OF THE INVENTION

Hereinafter, a detailed description will be given of embodiments of the present invention so that those of ordinary skill in the art to which the present invention belongs can easily implement the same with reference to the accompanying drawings. The present invention may be embodied in many different forms, and is not limited to the embodiments described herein.

Additional objects, features, and advantages of the present invention may be more clearly understood from the following detailed description and accompanying drawings. Before the detailed description of the present invention is provided, it is to be noted that the present invention may be variously changed and may have various embodiments, and the examples described below and shown in the drawings are not intended to limit the present invention to specific embodiments, but should be construed as covering modifications, equivalents or alternatives falling within the idea and technical scope of the present invention.

It will be understood that when an element is said to be “coupled” or “connected” to another element, it can be directly coupled or connected to the other element, or intervening elements may be present therebetween. In contrast, it should be understood that when an element is referred to as being “directly coupled” or “directly connected” to another element, there are no intervening elements present.

The terminology used herein is for the purpose of describing particular embodiments only and is not intended to be limiting. As used herein, the singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations thereof, but do not preclude the presence or addition of one or more other features, integers, steps, operations, elements, components, and/or combinations thereof.

In addition, terms such as “ . . . part”, “ . . . unit”, “ . . . module”, etc. described in the specification refer to units for processing at least one function or operation, and can be implemented by hardware, software, or a combination of hardware and software.

Furthermore, in the description with reference to the accompanying drawings, the same elements are assigned the same reference numerals throughout the drawings, and a redundant description thereof will be omitted. In describing the present invention, if it is determined that a detailed description of related known technology may unnecessarily obscure the gist of the present invention, a detailed description thereof will be omitted.

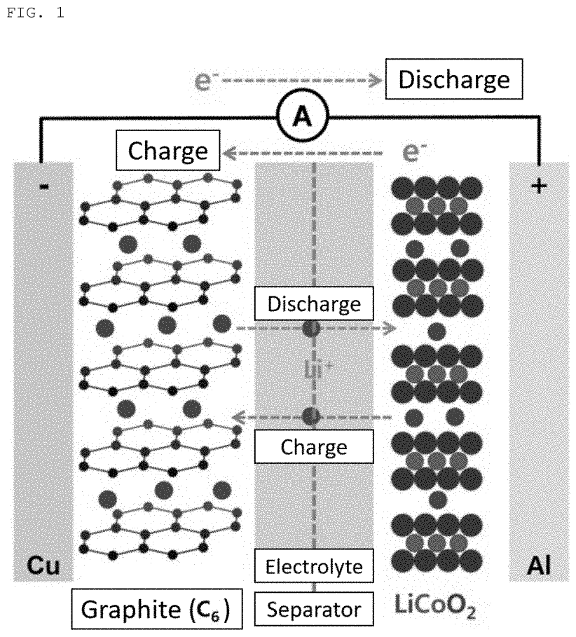

FIG. 1 shows a conventional secondary battery.

A conventional lithium-ion secondary battery includes a cathode material, an anode material, an electrolyte, and a separator. Here, graphite is used as the anode material. Graphite has a layered structure of carbon, and lithium ions may be intercalated into the carbon layer. Since the process of intercalating lithium into the carbon layer requires energy, lithium is intercalated during the charging process in which energy is applied from the outside, and lithium is deintercalated again during the discharging process to supply energy to the outside. Most currently commercially available lithium-ion batteries include graphite serving as an anode material, and a silicon-graphite composite or the like other than graphite is also used as the anode material.

The material used as the cathode material also has a layered structure. During the charging process, lithium is oxidized, is deintercalated from the cathode material, and moves to the anode, and during the discharging process, lithium is reduced again, and is intercalated into the cathode material. A material such as lithium iron phosphate (LiFePO₄), lithium manganese oxide (LiMn₂O₄), or the like is also useful as the cathode material.

An electrolyte is a liquid having ionic conductivity and functions as a path for movement of lithium ions during charging and discharging. The electrolyte that is used is an organic solvent such as ethylene carbonate in which a lithium salt (e.g. LiPF₆) is dissolved. The electrolyte solution has to have good ionic conductivity and low viscosity. The electrolyte must be free of water. The reason for this is that, if water is present, it will react with lithium and an explosion will occur. A separator is essential in order to prevent contact between the cathode material and the anode material, and a non-conductive polymer film is used therefor.

During the charging process, external energy is applied to move lithium ions from the cathode to the anode. At the cathode, lithium ions are deintercalated from the cathode material. The reaction when lithium cobalt oxide is used as a cathode material is as follows.

LiCoO₂→CoO₂+Li⁺+e⁻

Lithium ions deintercalated from the cathode move to the anode through the electrolyte, and electrons move to the anode through an external conductor. At the anode, lithium ions are intercalated into the anode material. The reaction when graphite is used as an anode material is as follows.

C₆+Li⁺+e⁻→LiC₆

The overall reaction during the charging process is as follows.

C₆+LiCoO₂→LiC₆+CoO₂

During the discharging process, lithium ions move from the anode to the cathode, supplying electric energy to the outside. Lithium ions are deintercalated from the anode and move to the cathode through the electrolyte. Electrons move to the cathode through an external conductor.

LiC₆→C₆+Li⁺+e⁻

Lithium ions moved to the cathode are reduced and intercalated into the cathode material.

CoO₂+Li⁺+e⁻→LiCoO₂

The overall reaction during the discharging process is as follows.

LiC₆+CoO₂→C₆+LiCoO₂

In lithium-ion secondary batteries, the cathode material, which influences the performance of secondary batteries and accounts for the greatest proportion of the cost thereof, is an alkali metal compound synthesized from a lithium compound material and a metal oxide. It may be synthesized using an oxide of a metal such as nickel, cobalt, manganese, aluminum or iron and lithium hydroxide or lithium carbonate, which is a lithium compound material. The anode material that is mainly used is artificial graphite or natural graphite, having excellent stability.

Currently, the capacity of the lithium-ion secondary battery is about 340 mAh/g after slow charging for 10 hours (0.1C), but is much lower, about 50 mAh/g, after fast charging for 12 minutes (5C).

In order to solve the problem in which the capacity of the secondary battery is rapidly decreased after fast charging, various charge techniques have been recently developed, and a technique for adding silicon to the anode material to realize high capacity after fast charging is being developed.

However, these techniques for fast charging have limitations in improving capacity and stability due to the inherent properties of cathode and anode materials.

Recently, it has been reported that electric vehicles are capable of traveling about 300-400 km after being charged for about 40 minutes using these techniques for fast charging. However, general consumers who prefer electric vehicles are demanding electric vehicles that have a driving distance of 500 km or more on a single charge taking 15 minutes or less.

However, with current technology, it is difficult to solve problems related to the charge capacity, stability, lifespan, and price of secondary batteries, which must be overcome in order to increase the market share of electric vehicles.

In the present invention, in order to solve the problems related to the charge capacity, lifespan, and price and supply of raw materials required for secondary batteries for electric vehicles, a conceptually new charge-discharge mechanism and new materials different from those of existing lithium-ion secondary batteries have been devised.

The capacity of a lithium-ion secondary battery is greatly dependent on the cathode material, and oxides of metals (nickel, cobalt, manganese, and aluminum) having high-capacity characteristics are mainly used. In particular, the higher the nickel content, the higher the capacity, and recently, nickel content has trended upwards to as high as 90%. Moreover, lithium-iron phosphate cathode materials having relatively low capacity have been used these days to reduce the cost of secondary batteries, which is a requirement for rapid growth of the electric vehicle market.

In addition, artificial graphite and natural graphite, having excellent stability, have mainly been used for the anode material, but there is a trend toward increasing use of a carbon-silicon composite containing about 5% silicon in order to increase the charge capacity.

When a carbon-silicon composite anode material containing about 5% silicon is used, the charge capacity is about 410 mAh/g, which is about 20% higher than 340 mAh/g, which is the charge capacity when graphite is used.

However, the anode material using a carbon-silicon composite is problematic in that the lifespan of the secondary battery is shortened due to the volume expansion of silicon with an increase in the silicon content, so it cannot be regarded as an efficient way to solve problems related to the stability, lifespan, and price of secondary batteries.

In currently available lithium-ion secondary batteries, the cathode material uses a lithium metal compound synthesized from metal oxide as a supply source for supplying lithium ions, and the anode material, functioning to store lithium ions supplied from the cathode material, mainly includes artificial graphite and natural graphite.

The cathode material using metal oxide and the anode material using graphite have currently reached technical limitations thereon in view of capacity increase, making it very difficult to satisfy performance requirements for secondary batteries for electric vehicles.

In the present invention, in order to solve the problems related to the charge capacity, lifespan, and price and supply of raw materials required for secondary batteries for electric vehicles, technology using a new charge-discharge mechanism and materials has been devised.

With the goal of solving problems related to the capacity, lifespan, and price of lithium- or sodium-ion secondary batteries, in the present invention, technology for an alkali-metal-ion secondary battery including alkali metal ions at high density on both sides thereof is provided, and is capable of obtaining the following effects.

First, in the technology devised in the present invention, the anode material is composed of an electrically conductive carbon allotrope and an alkali metal compound so that the anode material is also capable of partially playing the role of a cathode material supplying lithium or sodium ions, thereby increasing the total amount of lithium or sodium ions that are able to move inside the secondary battery, that is, the density of alkali metal ions in the secondary battery cell, ultimately effectively increasing the capacity of the secondary battery.

Conventionally, in order to increase capacity, a method of increasing the amount of nickel metal oxide in the cathode material up to 90% is being used, but a large amount of nickel metal oxide is used regardless. Since high nickel content results in poor stability, the capacity of the alkali-metal-ion secondary battery may be increased by allowing a large amount of alkali metal ions to move inside the secondary battery through the high-density alkali-metal-ion secondary battery technology using a lithium or sodium compound in both of the cathode material and the anode material according to the present invention.

Second, the technology for the alkali-metal-ion secondary battery including alkali metal ions at high density on both sides thereof according to the present invention, in which the lithium or sodium compound is contained in each of the cathode material and the anode material, has an effect of solving problems of deficiency of alkali metal ions due to side reactions during charging and discharging of the secondary battery and shortened lifespan of the secondary battery.

Third, the technology for the alkali-metal-ion secondary battery including alkali metal ions at high density on both sides thereof according to the present invention has an effect of shortening the charge time by reducing the length of the path along which alkali metal ions move to the anode during charging.

Fourth, the technology for the alkali-metal-ion secondary battery including alkali metal ions at high density on both sides thereof according to the present invention has an effect of stabilizing the supply and price of raw materials for secondary batteries by replacing the metal oxide used in the cathode material for the conventional alkali-metal-ion secondary battery with an inexpensive material that may be efficiently supplied.

The present invention pertains to an alkali-metal-ion secondary battery including alkali metal ions at high density on both sides thereof designed to improve the capacity and lifespan characteristics of a lithium-ion secondary battery, which is a conventional alkali-metal-ion secondary battery, and to solve problems related to the supply and price of raw materials for secondary batteries.

In order to compare the characteristics of the alkali-metal-ion secondary battery including alkali metal ions at high density on both sides thereof according to the present invention with conventional cases, a coin cell was manufactured using a ternary (nickel, cobalt, and manganese) lithium-metal oxide as a cathode material, LiPF₆ as an electrolyte, PE (polyethylene) as a separator, low-crystalline carbon, namely nanocarbon and multilayer graphene, as active materials for an anode material, low-crystalline carbon (Super P) as a conductive material, and PVDF as a binder.

In the present invention, the optimal result could be obtained through experiments using various examples and comparative examples in order to find the optimal configuration of the secondary battery through various combinations. Hereinafter, graphs showing result values for Comparative Examples 1 to 3 and Example 1 for some meaningful experiments based on which the present invention was devised, among the various experiments that were conducted, will be described with reference to FIGS.

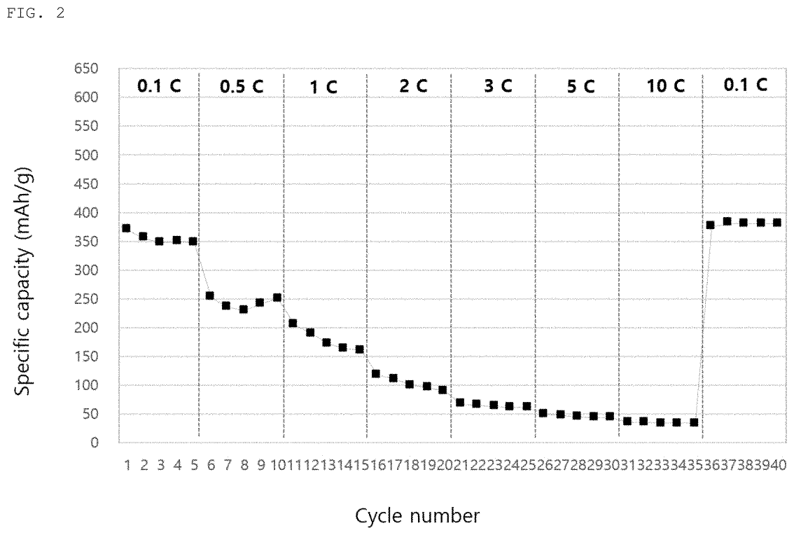

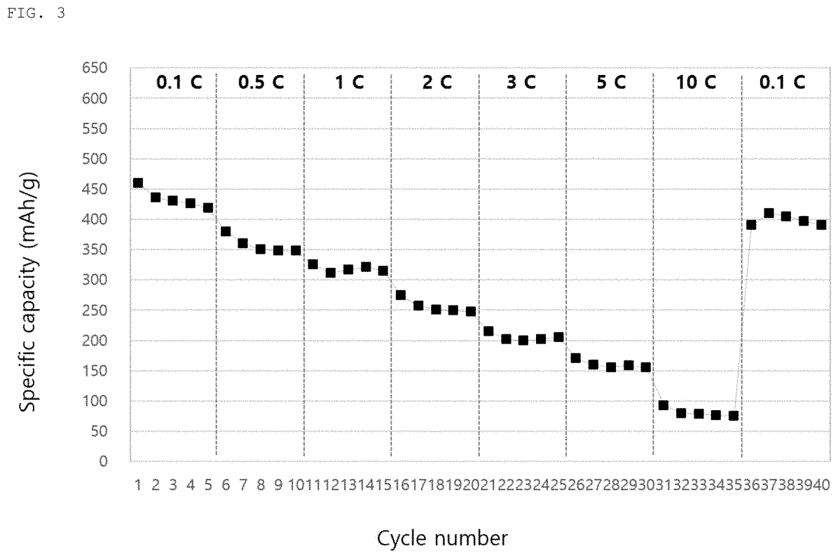

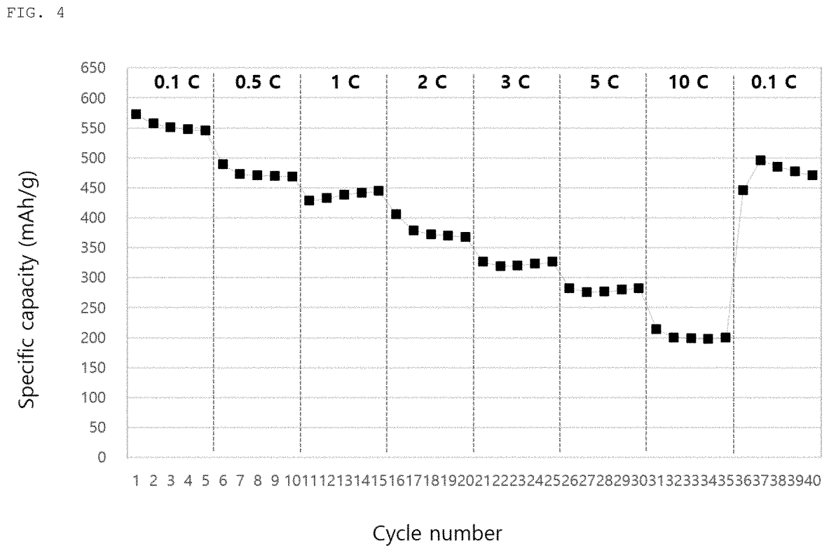

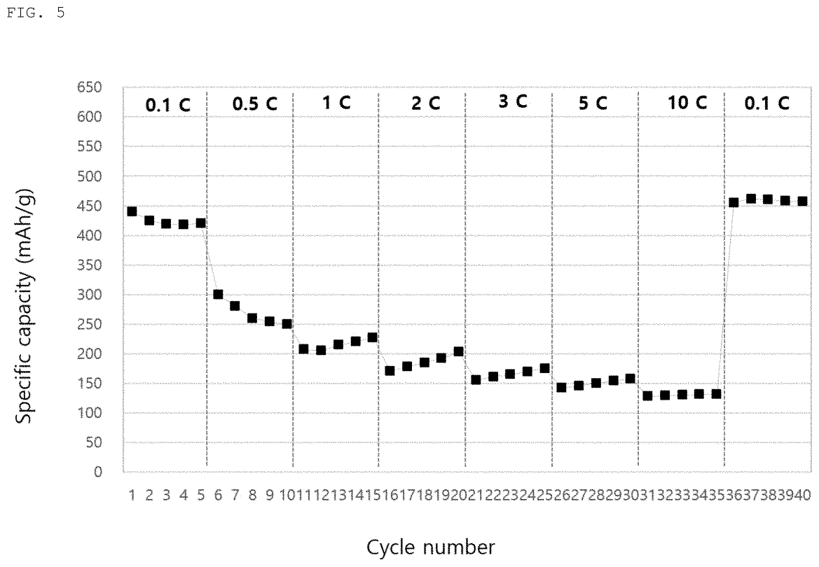

FIG. 2 shows a graph for Comparative Example 1, FIG. 3 shows a graph for Comparative Example 2, FIG. 4 shows a graph for Comparative Example 3, and FIG. 5 shows a graph for Example 1 according to the present invention.

FIG. 2 shows the capacity characteristics depending on the charge time of a lithium-ion secondary battery when multilayer graphene is used as an active material for an anode material in Comparative Example 1 for comparatively evaluating the effects of the present invention.

In Comparative Example 1, the active material used for the anode material and the conductive material were multilayer graphene and low-crystalline carbon, and the respective amounts (wt %) of multilayer graphene and low-crystalline carbon were 90 wt % and 10 wt %. The multilayer graphene used in Comparative Example 1 was non-oxidized multilayer graphene obtained by mechanically exfoliating natural graphite having a particle size of about 10 μm, and had an average particle size of about 2 μm, and the number of graphene layers was 10 to 20.

The low-crystalline carbon used as the conductive material had a particle size of about 40 nm and a specific surface area (BET) of 65 m²/g. PVDF was used as the binder.

FIG. 2 shows the capacity characteristics depending on the charge time when multilayer graphene having properties similar to graphite is used as the anode material in Comparative Example 1 for comparatively evaluating the effects of the present invention.

The capacity of the lithium-ion secondary battery of Comparative Example 1 was about 350 mAh/g after 5 cycles of charging for 10 hours (0.1C), and was about 50 mAh/g after 5 cycles of charging for 12 minutes (5C), indicating that the capacity decreases rapidly with a decrease in the charge time.

In order to evaluate the lifespan characteristics of lithium-ion secondary batteries, charging was performed for 5 cycles at each charge time ranging from 10 hours (0.1C) to 6 minutes (10C), after which slow charging was performed again for 5 10-hour cycles (0.1C). At this time, the capacity of the secondary battery was about 375 mAh/g.

As shown in FIG. 2, when multilayer graphene was used for the anode material, the capacity characteristics depending on the charge time were similar to when conventional natural graphite was used, but the capacity after 5 cycles of charging for 10 hours again subsequent to fast charging was 375 mAh/g, which is about 7% higher than 350 mAh/g, which was the initial capacity after 5 charge cycles. After 5 cycles of slow charging again following 5 repeated fast charging cycles, the capacity retention rate of the lithium-ion secondary battery is 95% or more of the initial capacity after 5 charge cycles at 0.1C.

As shown in FIG. 2, the capacity retention rate of the secondary battery after fast charging was higher than that of the conventional secondary battery using graphite. A high capacity retention rate means that the lifespan characteristics of the secondary battery are excellent.

Therefore, as shown in FIG. 2, the multilayer graphene prepared and used in the present invention is determined to be an electrically conductive carbon allotrope material suitable for improving the lifespan characteristics of the secondary battery to be achieved in the present invention.

FIGS. 3 and 4 show the capacity characteristics depending on the charge time of the lithium-ion secondary battery when the amount of the carbon-silicon composite that is added to the anode material is 12 wt % and 35 wt %, respectively, in Comparative Examples 2 and 3 for comparatively evaluating the effects of the present invention.

In Comparative Examples 2 and 3, the active material for the anode material was nanocarbon in which low-crystalline carbon having a particle size of about 70 nm was activated, and the multilayer graphene used in Comparative Example 1 was used as the conductive material. Also, in order to increase the capacity, an additive, that is, a carbon-silicon composite coated with electrically conductive carbon, was used in amounts of 12 wt % and 35 wt %.

In Comparative Examples 2 and 3, the active material used for the anode material was composed of low-crystalline nanocarbon and multilayer graphene at a weight ratio of 95:5. The carbon-silicon composite used for the anode material was used in amounts of 12 wt % and 35 wt %. The carbon-silicon composite was synthesized by mixing a silicon powder having a particle size of 800 nm and an organic compound in purified water and carbonizing the resulting mixture at 600° C. The respective amounts of silicon in the anode material were 5 wt % and 15 wt %. The same PVDF as in Comparative Example 1 was used as the binder.

In Comparative Example 2 of FIG. 3, the capacity of the lithium-ion secondary battery using 12 wt % of the silicon composite was about 434 mAh/g after 5 cycles of charging for 10 hours (0.1C), and was about 159 mAh/g after 5 cycles of charging for 12 minutes (5C), indicating that the capacity decreases rapidly with a decrease in the charge time.

In order to evaluate the lifespan characteristics of the lithium-ion secondary battery, charging was performed for 5 cycles at each charge time ranging from 10 hours (0.1C) to 6 minutes (10C), after which slow charging was performed again for 5 10-hour cycles (0.1C). At this time, the capacity of the secondary battery was about 398 mAh/g.

As shown in FIG. 3, the capacity after 5 cycles of slow charging for 10 hours again subsequent to fast charging was 398 mAh/g, which is about 8% lower than 434 mAh/g, which was the initial capacity after 5 charge cycles at 0.1C.

After 5 cycles of slow charging at 0.1C (10 hours) again following 5 repeated fast charging cycles up to 10C (6 minutes), the capacity retention rate of the lithium-ion secondary battery added with silicon was about 92% of the initial capacity after 5 charge cycles at 0.1C.

In Comparative Example 3 of FIG. 4, the capacity of the lithium-ion secondary battery using 35 wt % of the silicon composite was about 550 mAh/g after 5 cycles of charging for 10 hours (0.1C), and was about 275 mAh/g after 5 cycles of charging for 12 minutes (5C), indicating that the capacity decreases rapidly with a decrease in the charge time.

In order to evaluate the lifespan characteristics of the lithium-ion secondary battery, charging was performed for 5 cycles at each charge time ranging from 10 hours (0.1C) to 6 minutes (10C), after which slow charging was performed again for 5 10-hour cycles (0.1C). At this time, the capacity of the secondary battery was about 475 mAh/g.

As shown in FIG. 4, the capacity after 5 cycles of slow charging for 10 hours again subsequent to fast charging was 475 mAh/g, which is about 14% lower than 550 mAh/g, which was the initial capacity after 5 charge cycles at 0.1C.

After 5 cycles of slow charging at 0.1C (10 hours) again following 5 repeated fast charging cycles up to 10C (6 minutes), the capacity retention rate of the lithium-ion secondary battery added with silicon was about 86% of the initial capacity after 5 charge cycles at 0.1C.

As shown in FIGS. 3 and 4, the capacity retention rate of the secondary battery after fast charging at 10C (6 minutes) was about 92% and about 86%, respectively, which means that the lifespan characteristics of the lithium-ion secondary battery added with silicon are inferior to those of the conventional anode material using graphite.

When the carbon-silicon composite is used for the anode material, the capacity is greatly increased compared to when graphite is used. Graphite has the ability to store lithium ions through intercalation, and is capable of storing one lithium ion for every six carbon atoms. The theoretical charge capacity of graphite is 372 mAh/g. In contrast, silicon has the ability to store lithium ions through alloying with lithium, and is capable of storing four lithium ions per silicon atom.

The theoretical charge capacity of silicon is 4,200 mAh/g, which is about 10 times as high as that of graphite.

Since silicon actually has no electrical conductivity, it is used after being coated with electrically conductive carbon. Moreover, silicon is used in the form of a silicon-lithium alloy when storing lithium ions. As lithium is stored, silicon expands about 4 times in volume, and cracks in silicon crystals occur due to volume expansion, whereby electrical conductivity is lowered and lithium-ion storage capacity decreases.

The lithium-ion secondary battery using the carbon-silicon composite has high capacity, but is disadvantageous in view of the short lifespan thereof due to the volume expansion of silicon.

In order to solve the problem of the short lifespan of the secondary battery due to the volume expansion of silicon, silicon is used in an amount of about 5%. However, even when only a small amount of silicon is added and the silicon is coated with electrically conductive carbon, it is still very difficult to completely solve the lifespan problem due to the inherent volume expansion of silicon.

Typically, when 5% silicon is added, the capacity of the secondary battery after slow charging (0.1C) is about 430 mAh/g.

FIG. 5 shows the capacity characteristics depending on the charge time when an alkali metal compound synthesized from an electrically conductive carbon allotrope and a lithium-organic compound is used as the anode material in order to increase the capacity, improve the lifespan, and decrease the price of the material, in Example 1 for comparing the effect of the alkali-metal-ion secondary battery including alkali metal ions at high density on both sides thereof according to the present invention with conventional cases.

Example 1 is directed to an alkali-metal-ion secondary battery including alkali metal ions at high density on both sides thereof, in which an alkali metal compound used for a cathode material of a conventional lithium-ion secondary battery is also used for an anode material.

In Example 1, the anode material that was used was an alkali metal compound synthesized from low-crystalline nanocarbon, which is an electrically conductive carbon allotrope, lithium hydroxide, and an organic compound.

As a conductive material, 5 wt % of multilayer graphene having excellent electrical conductivity was used.

In Example 1, respective amounts of the low-crystalline nanocarbon including the multilayer graphene conductive material and the lithium compound were 79 wt % and 21 wt %.

In Example 1, the lithium compound that was used was synthesized from low-crystalline nanocarbon, lithium hydroxide, and melamine containing an amino group as an organic compound.

When synthesizing the lithium compound in Example 1, the composition ratio of lithium hydroxide to melamine was 1:1.7.

In Example 1, in order to ensure the electrical conductivity of the lithium compound, when synthesizing the anode material, nanocarbon, which is an electrically conductive carbon allotrope, lithium hydroxide, and melamine were mixed and treated at a high temperature. In order to improve the electrical conductivity of the lithium compound, the lithium compound may be coated with carbon, or a binder may be used so that the electrically conductive carbon allotrope and the lithium compound are strongly bound to each other or come into strong contact with each other.

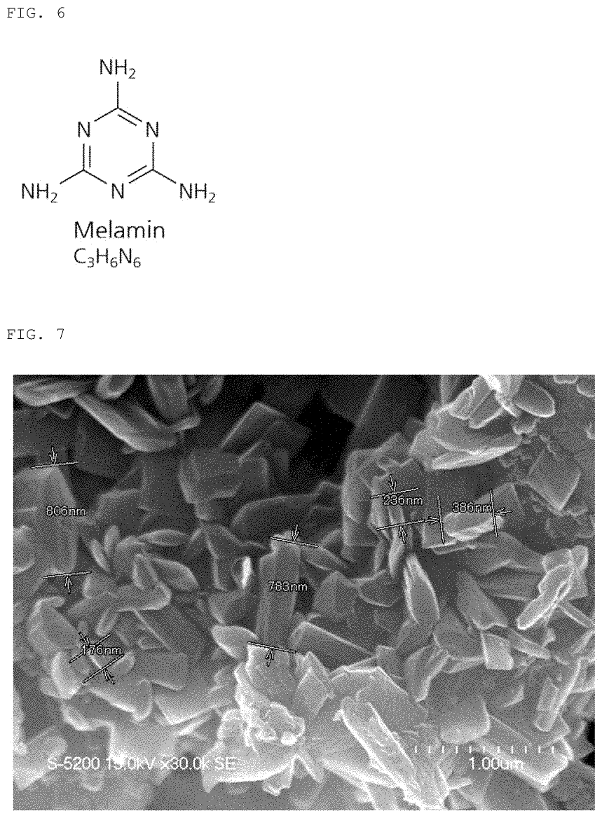

The organic compound used to synthesize the lithium compound was melamine. Melamine, which is a kind of amine, is a basic organic nitrogen compound containing an amino group (—NH₂), and the chemical structure of melamine (C₃H₆N₆) is illustrated in FIG. 6

Another organic compound containing an amino group is urea, which is capable of forming a lithium-organic compound, like melamine.

Melamine is a single crystal or colorless rod-shaped crystal having a melting point of 347° C., is also called ‘triamide triazine’, and is a heterocyclic amine. Three amino groups in the 1,3,5-triazine ring bind to lithium ions to form a lithium-organic compound such as lithium amide.

A base is a material that emits hydroxide ions or absorbs protons in an aqueous solution, and is commonly called an alkali. A base is a material corresponding to an acid, and undergoes mutual neutralization therewith to form salt and water. A base is an electrolyte, like most metal oxides.

In general, lithium amide (LiNH₂) is an inorganic compound composed of Li⁺ and NH₂⁻, also called lithamide.

The conjugate base of an amine anion is known as an amide. Lithium amide is therefore related to compounds belonging to the lithium salts of amines. This chemical has a common form of Li⁺ and NR₂⁻, with lithium amide as the parent structure. Lithium amide is a highly reactive compound, and is able to act as a strong base.

Example 1 of the present invention is technology that allows a large amount of lithium ions to move inside the secondary battery due to the lithium compound contained in the anode material in the lithium-ion secondary battery. Although melamine having an amino group was used to synthesize a lithium compound, in the technology of the present invention, an alkali metal compound may be synthesized using various basic organic compounds capable of binding to lithium or sodium ions.

FIG. 7 shows an electron microscope (SEM) image of a lithium compound including nanocarbon, which is a low-crystalline carbon, and multilayer graphene, prepared in Example 1 of the present invention.

It is also possible to synthesize an alkali metal compound using an inorganic compound for which the price and supply of raw materials are stable by using an inorganic compound suitable for synthesis of a lithium or sodium compound, namely a low-molecular-weight inorganic compound such as boric acid, or by using an inexpensive metal oxide such as iron instead of an expensive metal oxide such as cobalt, and to use the same for an anode material or a cathode material.

FIG. 5 shows the capacity characteristics depending on the charge time of the alkali-metal-ion secondary battery including alkali metal ions at high density on both sides thereof according to the present invention.

The capacity of the alkali-metal-ion secondary battery including alkali metal ions at high density on both sides thereof of Example 1 was about 420 mAh/g after 5 cycles of charging for 10 hours (0.1C), and was about 150 mAh/g after 5 cycles of charging for 12 minutes (5C), indicating that the capacity decreases with a decrease in the charge time. Compared to about 50 mAh/g, which is the 12-minute (5C) charge capacity of the conventional lithium-ion secondary battery using a graphite anode material, the 12-minute (5C) charge capacity of the alkali-metal-ion secondary battery including alkali metal ions at high density on both sides thereof according to the present invention was about 150 mAh/g, which is about 3 times as high as the fast charge capacity of a conventional lithium-ion secondary battery. This proves that the alkali-metal-ion secondary battery including alkali metal ions at high density on both sides thereof according to the present invention has an effect of reducing the length of the movement path of alkali metal ions.

In order to evaluate the lifespan characteristics of the alkali-metal-ion secondary battery according to the present invention, charging was performed for 5 cycles at each charge time ranging from 10 hours (0.1C) to 6 minutes (10C), after which slow charging was performed again for 5 10-hour cycles (0.1C). At this time, the capacity of the secondary battery was about 455 mAh/g.

As shown in FIG. 5, the capacity after 5 cycles of charging for 10 hours (0.1C) again subsequent to fast charging at 10C (6 minutes) was 455 mAh/g, which is about 8% higher than 420 mAh/g, which was the initial capacity after 5 charge cycles at 0.1C.

After slow charging again following repeated fast charging, the capacity retention rate of the secondary battery was 108% of the initial capacity.

As shown in FIG. 5, the capacity retention rate of the secondary battery after fast charging was 108%, indicating that the lifespan thereof was superior to that of the lithium-ion secondary battery added with silicon.

As is apparent from Example 1, the alkali-metal-ion secondary battery including alkali metal ions at high density on both sides thereof according to the present invention is different from the conventional lithium-ion secondary battery with regard to the charge-discharge mechanism and materials.

By synthesizing the anode material using the lithium-organic compound containing an amino group, a sufficient amount of lithium ions capable of moving inside the secondary battery is ensured, and pre-reaction of alkali metal and components that interfere with charging and discharging in the anode is caused, thus minimizing the deficiency of alkali metal ions due to side reactions during charging and discharging, thereby increasing the capacity of the secondary battery and extending the lifespan of the secondary battery. Moreover, the length of the movement path of alkali metal ions is reduced due to the alkali metal compound in the anode material, thereby enabling fast charging of the secondary battery.

The alkali-metal-ion secondary battery according to the present invention includes a cathode material, an electrolyte, a separator, and an anode material, in which each of the cathode material and the anode material includes an electrically conductive carbon allotrope and an alkali metal compound. Here, the electrically conductive carbon allotrope contained in the cathode material and the electrically conductive carbon allotrope contained in the anode material are different from each other with regard to the weight or composition ratio thereof, and the alkali metal compound contained in the cathode material and the alkali metal compound contained in the anode material are different from each other with regard to the weight or composition ratio thereof.

The electrically conductive carbon allotrope contained in each of the cathode material and the anode material includes at least one selected from among natural graphite, artificial graphite, low-crystalline carbon, activated carbon, graphene, and carbon nanotubes, and the alkali metal compound contained in each of the cathode material and the anode material includes at least one selected from among a lithium compound and a sodium compound.

The lithium compound is synthesized from at least one selected from among lithium hydroxide, lithium oxide, and lithium carbonate, and the sodium compound is synthesized from at least one selected from among sodium chloride, sodium hydroxide, sodium oxide, and sodium carbonate.

The alkali metal compound contained in each of the cathode material and the anode material is synthesized from at least one material selected from among an inorganic compound and an organic compound, and the cathode material and the anode material are prepared by forming the alkali metal compound or by applying the alkali metal compound.

The organic compound used to synthesize the lithium compound or the sodium compound includes an organic compound containing an amino group (—NH₂), and the organic compound containing an amino group (—NH₂) is melamine or urea.

As is apparent from the above description, according to the present invention, provided is an alkali-metal-ion secondary battery including a cathode material, an electrolyte, a separator, and an anode material, in which each of the cathode material and the anode material includes an electrically conductive carbon allotrope and an alkali metal compound, the electrically conductive carbon allotrope contained in the cathode material and the electrically conductive carbon allotrope contained in the anode material being different from each other with regard to the weight or composition ratio thereof, and the alkali metal compound contained in the cathode material and the alkali metal compound contained in the anode material being different from each other with regard to the weight or composition ratio thereof.

Although the embodiments of the present invention have been described above with reference to the accompanying drawings, those skilled in the art to which the present invention belongs will understand that the present invention may be embodied in other specific forms, without departing from the technical spirit or essential characteristics thereof.

Therefore, the embodiments described above are to be understood as illustrative and not restrictive in all aspects, the scope of the present invention is indicated by the following claims, and all changes or modifications derived from the meaning and scope of the claims and equivalents thereof should be construed as being incorporated in the scope of the present invention.

What is claimed is:

1. An alkali-metal-ion secondary battery, comprising:
a cathode material;
an electrolyte;
a separator; and
an anode material,
wherein each of the cathode material and the anode material comprises an electrically conductive carbon allotrope and an alkali metal compound.

2. The alkali-metal-ion secondary battery according to claim 1, wherein a weight or composition ratio of the electrically conductive carbon allotrope contained in the cathode material is different from a weight or composition ratio of the electrically conductive carbon allotrope contained in the anode material.

3. The alkali-metal-ion secondary battery according to claim 1, wherein a weight or composition ratio of the alkali metal compound contained in the cathode material is different from a weight or composition ratio of the alkali metal compound contained in the anode material.

4. The alkali-metal-ion secondary battery according to claim 1, wherein the electrically conductive carbon allotrope contained in each of the cathode material and the anode material comprises at least one selected from among natural graphite, artificial graphite, low-crystalline carbon, activated carbon, graphene, and carbon nanotubes.

5. The alkali-metal-ion secondary battery according to claim 4, wherein the alkali metal compound contained in each of the cathode material and the anode material comprises at least one selected from among a lithium compound and a sodium compound.

6. The alkali-metal-ion secondary battery according to claim 5, wherein the lithium compound is synthesized from at least one selected from among lithium hydroxide, lithium oxide, and lithium carbonate.

7. The alkali-metal-ion secondary battery according to claim 5, wherein the sodium compound is synthesized from at least one selected from among sodium chloride, sodium hydroxide, sodium oxide, and sodium carbonate.

8. The alkali-metal-ion secondary battery according to claim 5, wherein the alkali metal compound contained in each of the cathode material and the anode material is synthesized from at least one material selected from among an inorganic compound and an organic compound, and the cathode material and the anode material are prepared by forming the alkali metal compound or applying the alkali metal compound.

9. The alkali-metal-ion secondary battery according to claim 4, wherein the alkali metal compound contained in each of the cathode material and the anode material is synthesized from at least one material selected from among an inorganic compound and an organic compound and at least one material selected from among electrically conductive carbon allotropes, and the cathode material and the anode material are prepared by forming the alkali metal compound or applying the alkali metal compound.

10. The alkali-metal-ion secondary battery according to claim 8, wherein the organic compound used to synthesize the lithium compound or the sodium compound comprises an organic compound containing an amino group (—NH₂).

11. The alkali-metal-ion secondary battery according to claim 10, wherein the organic compound containing an amino group (—NH₂) is melamine or urea.

12. The alkali-metal-ion secondary battery according to claim 9, wherein the organic compound used to synthesize the lithium compound or the sodium compound comprises an organic compound containing an amino group (—NH₂).

13. The alkali-metal-ion secondary battery according to claim 12, wherein the organic compound containing an amino group (—NH₂) is melamine or urea.

14. The alkali-metal-ion secondary battery according to claim 5, wherein the alkali metal compound contained in each of the cathode material and the anode material is synthesized from at least one material selected from among an inorganic compound and an organic compound and at least one material selected from among electrically conductive carbon allotropes, and the cathode material and the anode material are prepared by forming the alkali metal compound or applying the alkali metal compound.
